(19) United States
(12) Patent Application Publication
(10) Pub. No.: US 2024/0351243 A1
(43) Pub. Date: Oct. 24, 2024

(54) KNEADER

(71) Applicant: HONDA MOTOR CO., LTD., Tokyo (JP)

(72) Inventor: Kentaro Sugimura, Wako-shi, Saitama-ken (JP)

(21) Appl. No.: 18/570,992

(22) PCT Filed: Jun. 22, 2021
(86) PCT No.: PCT/JP2021/023643

§ 371 Date: Dec. 15, 2023

(51) Int. Cl. B28C 5/18; B28C 5/12; H01M 50/251

(52) U.S. Cl. CPC B28C 5/1856; B28C 5/12; H01M 50/251; H01M 2220/10

(57) ABSTRACT

A kneader includes a drum and a battery case. An intake port for taking in material to be kneaded is formed in the drum. An accommodation part is formed in the battery case. An opening for inserting a removable battery, or for retrieving the removable battery, is formed in the accommodation part. The battery case is retained in the kneader while oriented in a manner other than an orientation in which the opening faces the drum.

### TECHNICAL FIELD

The present invention relates to a kneading machine (kneader) equipped with a stirring member that stirs a material to be kneaded, and a motor that rotates the stirring member.

### BACKGROUND ART

As is well known, a kneading machine is equipped with a drum, a stirring member for stirring a material to be kneaded, and a rotational drive source for rotationally driving the stirring member. For example, cement, sand, and water are accommodated inside the drum, as materials to be kneaded. Thereafter, by the stirring member being rotated, these materials are kneaded to obtain mortar.

In a pot-type kneading machine, the material to be kneaded is stirred by rotating the drum. In this manner, in the pot-type kneading machine, the drum itself serves as a stirring member. In such a pot-type kneading machine, there is also a case in which, in order to obtain concrete, gravel or the like may be further added as a material to be kneaded.

In this type of kneading machine, as disclosed in JP 4292472 B2, in recent times, a motor is frequently used as the rotational drive source. In such a configuration, in order to drive the motor, electrical power is supplied with respect to the motor. In JP 4292472 B2, although a specific description thereof is not provided, based on the constituent elements shown in the drawings, it is presumed that the power supply source for supplying the electrical power is an external electrical power source.

### SUMMARY OF THE INVENTION

In the case that the external electrical power source is a commercial electrical power source, it is necessary to provide the kneading machine with an electrical power supply cable, and to connect a plug of the electrical power supply cable to an outlet. Accordingly, the kneading machine cannot be used outside of a range within which the plug is capable of being connected to an outlet. Stated otherwise, in this case, the area within which the kneading machine is capable of being used is limited.

The present invention has the object of solving the aforementioned problem.

According to an embodiment of the present invention, there is provided a kneading machine equipped with a drum configured to accommodate a material to be kneaded, a stirring member configured to stir the material to be kneaded inside the drum, and a motor configured to rotate the stirring member, the kneading machine including:
a battery case configured to accommodate an attachable and detachable battery configured to supply electrical power to the motor; and
a pedestal configured to support the drum,
wherein an input opening through which inputting of the material to be kneaded is performed is formed in the drum;

an accommodation portion configured to accommodate the attachable and detachable battery is formed in the battery case, and an opening through which the attachable and detachable battery is inserted or removed is formed in the accommodation portion; and
the battery case is retained in a state in which the opening of the battery case is placed in a posture other than a posture in which the opening of the battery case faces toward the drum.

Moreover, it should be noted that in the present invention, a case is included in which the drum also serves in a dual manner as the stirring member. More specifically, the drum itself may serve as the stirring member. As an example of such a kneading machine, a pot-type kneading machine is exemplified, however, the present invention also includes a kneading machine in which a drum is positioned and fixed in place, such as a grout-type kneading machine or the like. In this case, the stirring member is provided as a member separate from the drum.

In the present invention, an attachable and detachable battery serves as an electrical power source. In this case, there is no need to insert the plug of an electrical power supply cable into an outlet. Accordingly, it is possible to use the kneading machine, even in locations other than in the vicinity of a commercial electrical power source. In other words, the range within which the kneading machine is capable of being used is expanded.

Further, in a kneading machine, at a time when the material to be kneaded is put thereinto through the input opening, and when the material to be kneaded is stirred, dust is likely to be generated in close proximity to the input opening. In this instance, according to the present invention, the opening of the battery case is placed in a posture other than in a posture facing toward the drum. More specifically, the opening does not face toward the drum. Therefore, the battery case and the attachable and detachable battery can be protected from dust.

### BRIEF DESCRIPTION OF DRAWINGS

FIG. 1 is a schematic left side view of a first pot-type kneading machine according to a first embodiment of the present invention;

FIG. 2 is a schematic plan view as seen from above of a battery case mounted on the first pot-type kneading machine;

FIG. 3 is a schematic cross-sectional view of a left side of a storage box and the battery case;

FIG. 4 is a front view of principal components showing a state in which a drum is inclined from a posture thereof shown in FIG. 1;

FIG. 5 is a schematic exploded perspective view of a second pot-type kneading machine according to a second embodiment of the present invention, as viewed from a right frontward direction;

FIG. 6 is a schematic right side view of the second pot-type kneading machine when the drum is in an ascended posture;

FIG. 7 is a schematic cross-sectional view of a right side of a storage box and a battery case; and

FIG. 8 is a schematic right side view of the second pot-type kneading machine when the drum is in a descended posture.

### DETAILED DESCRIPTION OF THE INVENTION

In first and second embodiments to be described below, a pot-type kneading machine in which a drum serves in a dual manner as a stirring member is illustrated as the kneading machine.

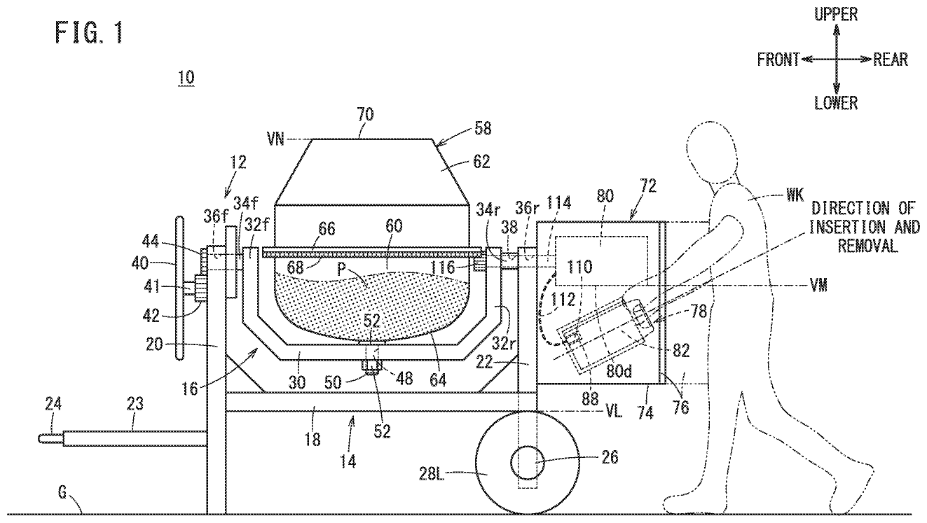

Moreover, in the first embodiment described below, a direction in which a towing bar 23 is provided defines a “front” of a first pot-type kneading machine 10 shown in FIG. 1, and a direction in which a left vehicle wheel 28L and a right vehicle wheel 28R are provided defines a “rear” thereof. Further, unless otherwise specified, the terms “left” and “right” refer respectively to a leftward direction and a rightward direction at a time when a worker WK views the first pot-type kneading machine 10 from the rear to the front thereof. Furthermore, the term “higher position” represents a height position where a straight-line distance from the ground surface G is relatively large. The term “lower position” represents a height position where a straight-line distance from the ground surface G is relatively small. The terms “higher position” and “lower position” do not necessarily mean that these positions are arranged vertically above and below one another.

FIG. 1 is a schematic left side view of the first pot-type kneading machine 10 according to a first embodiment of the present invention. In FIG. 1, a front part of the first pot-type kneading machine 10 faces toward a leftward direction of the drawing, and a rear part of the first pot-type kneading machine 10 faces toward a rightward direction of the drawing.

The first pot-type kneading machine 10 is equipped with a pedestal 12. This pedestal 12 includes a main frame 14, and a U-shaped member 16 that is provided to be capable of being tilted with respect to the main frame 14. Among these elements, the main frame 14 has a shape formed by a base beam portion 18, a front columnar portion 20, and a rear columnar portion 22 being connected in a substantially U-shape. The relatively long base beam portion 18 extends along a front-rear direction of the first pot-type kneading machine 10. Further, the front columnar portion 20 is joined to a front end of the base beam portion 18 and extends along an upper-lower direction. The rear columnar portion 22 is joined to a rear end of the base beam portion 18 and extends along the upper-lower direction.

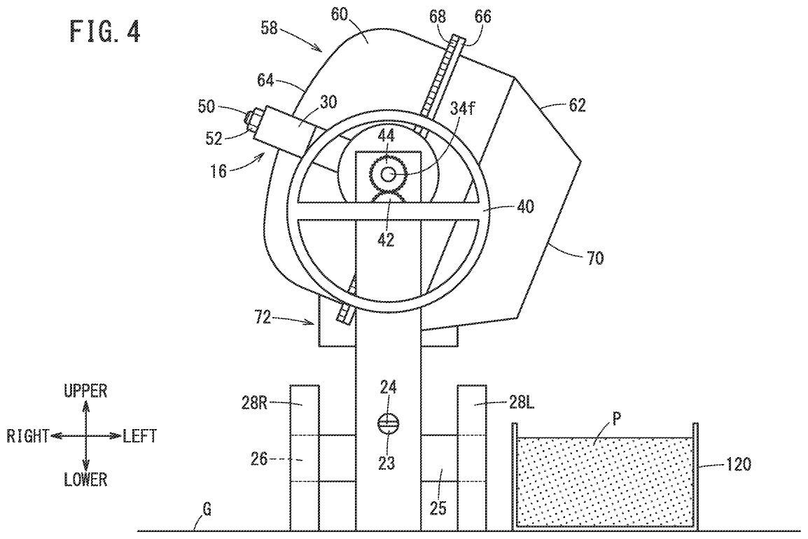

The lower end of each of the front columnar portion 20 and the rear columnar portion 22 extends further downward than the base beam portion 18. The towing bar 23 is connected to the front columnar portion 20. Although detailed illustration thereof is omitted, a ring portion 24 is provided on the front end of the towing bar 23. A hook or the like of a non-illustrated towing vehicle can be hooked onto this ring portion 24. Further, a round pipe 25 which is shown in FIG. 4 is joined to a lower end of the rear columnar portion 22.

A connecting shaft 26 is passed through the round pipe 25. A left end and a right end of the connecting shaft 26 are exposed from the round pipe 25. The left vehicle wheel 28L and the right vehicle wheel 28R are retained at the left end and the right end. The left vehicle wheel 28L, the connecting shaft 26, and the right vehicle wheel 28R rotate integrally together as a single rotating body. The center of rotation of the rotating body is the connecting shaft 26. Moreover, as shown in FIG. 1, the right vehicle wheel 28R overlaps with the left vehicle wheel 28L.

The U-shaped member 16 has a substantially U-shape in a side view of the first pot-type kneading machine 10. Specifically, the U-shaped member 16 includes a rod-shaped part 30 that is at a lowest position in FIG. 1 and which is elongated in the front-rear direction, a first leg portion 32f, and a second leg portion 32r. The first leg portion 32f rises upward from a front end of the rod-shaped part 30. A first tilting shaft 34f that extends toward the front is provided at an upper front part of the first leg portion 32f. The second leg portion 32r rises upward from a rear end of the rod-shaped part 30. A second tilting shaft 34r that extends toward the rear is provided at an upper rear part of the second leg portion 32r.

The first tilting shaft 34f and the second tilting shaft 34r are provided at positions spaced apart from each other by approximately 180 degrees. Further, the height of the first tilting shaft 34f and the height of the second tilting shaft 34r from the ground surface G are substantially equivalent to each other.

A first bearing hole 36f is formed in an upper part of the front columnar portion 20. The first tilting shaft 34f is slidably inserted in the first bearing hole 36f. Further, a second bearing hole 36r is formed in an upper part of the rear columnar portion 22. The second tilting shaft 34r is slidably inserted in the second bearing hole 36r. Moreover, it should be noted that bearings may be accommodated inside the first bearing hole 36f and inside the second bearing hole 36r.

By being inserted in the manner described above, the front columnar portion 20 (the front upper part of the main frame 14) and the first leg portion 32f (the front upper part of the U-shaped member 16) are connected via the first tilting shaft 34f. Further, the second leg portion 32r (the rear upper part of the U-shaped member 16) and the rear columnar portion 22 (the rear upper part of the main frame 14) are connected via the second tilting shaft 34r. The first tilting shaft 34f and the second tilting shaft 34r are restrained by the U-shaped member 16. However, the first tilting shaft 34f and the second tilting shaft 34r are not restrained by the front columnar portion 20 and the rear columnar portion 22. Accordingly, the U-shaped member 16 is capable of rotating (being tilted) upward or downward about the first tilting shaft 34f and the second tilting shaft 34r.

In this instance, an insertion hole 38 that extends along the front-rear direction is formed in the second tilting shaft 34r. More specifically, the second tilting shaft 34r is a hollow cylindrically shaped body. Moreover, it should be noted that the first tilting shaft 34f may be a hollow cylindrically shaped body in the same manner as the second tilting shaft 34r. Alternatively, the first tilting shaft 34f may be a solid cylindrically shaped body.

An angle adjustment handle 40 is rotatably supported on the front columnar portion 20. On a rotating shaft 41 of the angle adjustment handle 40, a first tilting gear 42 is provided on the outer periphery thereof. Further, a second tilting gear 44 is provided on the outer periphery of the first tilting shaft 34f. The first tilting gear 42 and the second tilting gear 44 mesh with one another. Accordingly, when the worker WK turns the angle adjustment handle 40, the second tilting gear 44 is driven to rotate. Along therewith, together with the rotation of the first tilting shaft 34f, the U-shaped member 16 also rotates. The second tilting shaft 34r also rotates integrally with the first tilting shaft 34f.

Although not particularly illustrated, a well-known locking mechanism (restricting portion) is provided on the first tilting gear 42. At a time when the locking mechanism has locked the angle adjustment handle 40, the angle adjustment handle 40 is incapable of being rotated. Accordingly, the U-shaped member 16 cannot be tilted either. In this manner, when the locking mechanism is in operation, the U-shaped member 16 is positioned and fixed in place. Accordingly, in order to cause the U-shaped member 16 to tilt, it is necessary to release the locking mechanism beforehand.

An insertion hole 48 is formed in the rod-shaped part 30 along the vertical direction. An upper part of a support shaft 50 is passed through the insertion hole 48. The diameter of the support shaft 50 is set to be slightly smaller than that of the insertion hole 48. Further, retaining members 52 which are larger in diameter than the insertion hole 48 are provided on the outer peripheries of portions of the support shaft 50 that are exposed from the insertion hole 48. By sandwiching the rod-shaped part 30 with these retaining members 52, the support shaft 50 is prevented from coming out from the insertion hole 48. Moreover, a nut or the like may be cited as a specific example of the retaining members 52.

A hollow drum 58 is provided on an upper end of the support shaft 50. The drum 58 is made up from a bottomed cup portion 60 having an approximately constant inner diameter, and a tapered tubular portion 62 that is connected to the cup portion 60 and reduces in diameter in a tapered shape. The upper end of the support shaft 50 is connected, for example by a screw connection, to a closed bottom portion 64 (a closed wall) in the interior of the cup portion 60. Therefore, the drum 58 is capable of rotating integrally together with the support shaft 50. Further, a flange portion 66, which projects toward a diametrically outward direction, is provided on an outer circumferential wall of the cup portion 60. Furthermore, a first rotating gear 68 is engraved on a lower surface of the flange portion 66.

A distal end of the tapered tubular portion 62, which is smallest in diameter, is an open end. This open end serves as an input opening 70 for the purpose of putting a material to be kneaded P into the drum 58. At a time when the drum 58 is in an upright posture facing vertically upward, the input opening 70 becomes placed at the highest position. At this time, the material to be kneaded P is stored at the bottom of the cup portion 60.

A non-illustrated stirring blade is provided on an inner wall of the drum 58. Accompanying the rotation of the drum 58, the stirring blade rotates integrally together with the drum 58.

A storage box 72 is supported on a rear end surface of the rear columnar portion 22. The storage box 72 includes a box main body 74 that has a rectangular tubular shape, and a lid body 76. The box main body 74 has an open end only at the rear end thereof. The lid body 76 is connected to the box main body 74 via a non-illustrated hinge. By being rotated about the hinge, the lid body 76 opens and closes the open end. As can be understood from this feature, the open end of the box main body 74 faces in an opposite direction to the direction in which the drum 58 is disposed. More specifically, the direction in which the open end opens does not face toward the direction in which the drum 58 is disposed. The box main body 74 is supported by the rear columnar portion 22 in a manner so as to have such a posture.

A battery case 78 and a motor 80 are accommodated in an inner chamber that is formed in the box main body 74. More specifically, the battery case 78 and the motor 80 are supported on the pedestal 12 via the storage box 72. Moreover, although according to the present embodiment, the drum 58, the battery case 78, and the motor 80 are supported on the pedestal 12, for example, it is also possible for a pedestal that supports the drum 58, and a pedestal that supports the battery case 78 to be provided as separate members.

The box main body 74 is provided at a higher position than the connecting shaft 26 and upper ends of the left vehicle wheel 28L and the right vehicle wheel 28R. Accordingly, the battery case 78 as well is also at a higher position than the connecting shaft 26 and the upper ends of the left vehicle wheel 28L and the right vehicle wheel 28R. Further, a front end of the battery case 78 is positioned upwardly of the left vehicle wheel 28L and the right vehicle wheel 28R. In this instance, a virtual horizontal line VL shown in FIG. 1 indicates the upper ends of the left vehicle wheel 28L and the right vehicle wheel 28R.

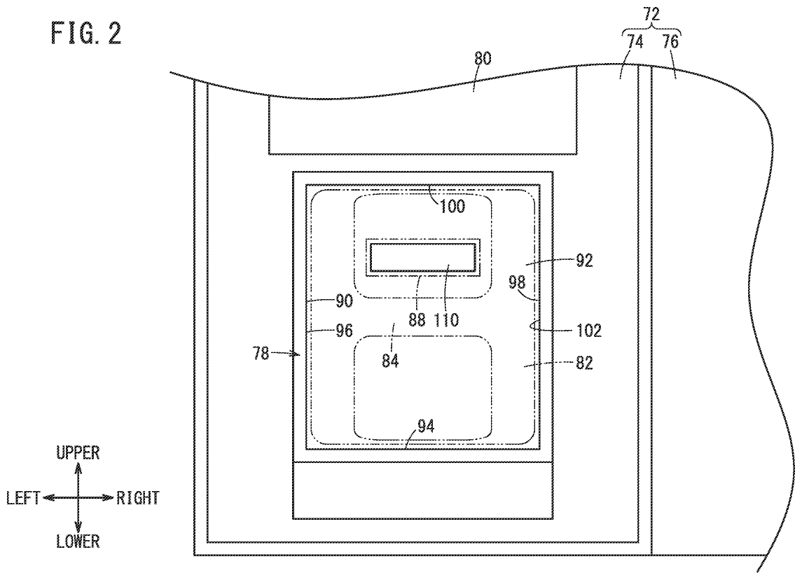

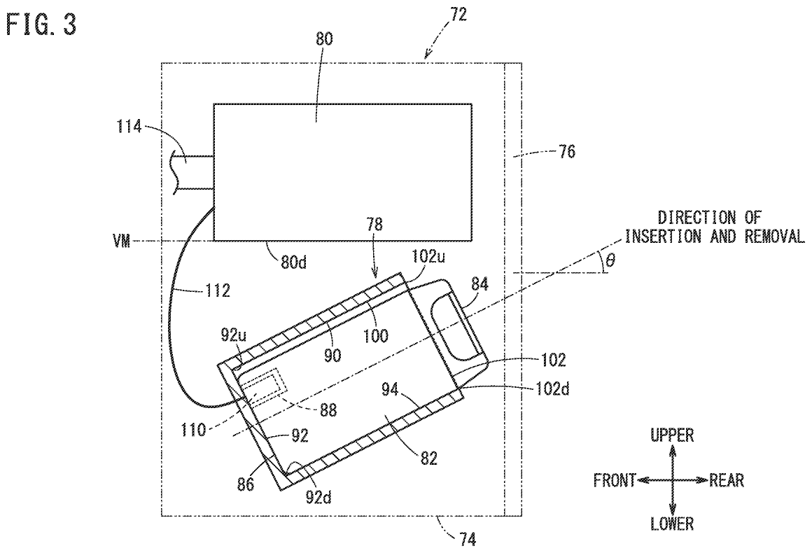

As shown in FIG. 2 and FIG. 3, an attachable and detachable battery 82 is attachably and detachably accommodated in the battery case 78. Concerning the attachable and detachable battery 82, a brief description thereof will be given below.

The attachable and detachable battery 82 has a substantially rectangular parallelepiped shape, similar to that shown in FIG. 1 of JP 2019-068720 A. A handle portion 84 in order to be grasped by a worker WK is provided on a first end of the attachable and detachable battery 82 in the longitudinal direction. In the case of lifting up the attachable and detachable battery 82, and in the case of transporting the attachable and detachable battery, the worker WK grasps the handle portion 84. Moreover, it should be noted that the second end of the attachable and detachable battery 82 in the longitudinal direction (the side opposite to the first end where the handle portion 84 is provided) is a substantially flat bottom surface 86 (refer to FIG. 3). A first connector 88 of a female type is provided on the bottom surface 86.

As shown in detail in FIG. 2, an accommodation hole 90 (an accommodation portion) in which the attachable and detachable battery 82 can be accommodated is formed in the battery case 78. The accommodation hole 90 is formed in a shape like that of a rectangular parallelepiped that has been hollowed out. Accordingly, the accommodation hole 90 is formed so as to have an inner wall made up of five walls including a bottom wall 92, a lower wall 94, a left side wall 96, a right side wall 98, and an upper wall 100. Further, an opening 102 for the purpose of inserting the attachable and detachable battery 82 into the accommodation hole 90 or for the purpose of removing the attachable and detachable battery from the accommodation hole 90 is formed in an upper end of the accommodation hole 90.

As shown in detail in FIG. 3, the battery case 78 is placed in a predetermined inclined posture. The predetermined inclined posture is defined as a posture in which the opening 102 faces toward the rear part and further faces toward the upper part of the storage box 72, and the bottom wall 92 faces toward the front part and further faces toward the lower part of the storage box 72. More specifically, the bottom wall 92 faces toward the closed bottom portion 64 of the drum 58. Therefore, the direction in which the attachable and detachable battery 82 is inserted into and removed from the accommodation hole 90 (i.e., the direction in which the opening 102 of the battery case 78 faces) is inclined toward the direction away from the input opening 70 of the drum 58. In this manner, the opening 102 does not face toward the drum 58. More specifically, the battery case 78 is accommodated in the box main body 74 in a state of being in the predetermined inclined posture. The predetermined inclined posture is defined as a posture other than a posture in which the opening 102 faces toward the drum 58.

A rear end of the lower wall 94 corresponds to a lower end 102d of the opening 102, and a rear end of the upper wall 100 corresponds to an upper end 102u of the opening 102. Further, a front end of the lower wall 94 corresponds to a lower end 92d of the bottom wall 92, and a front end of the upper wall 100 corresponds to an upper end 92u of the bottom wall 92. The lower end 102d of the opening 102 is at a higher position than the lower end 92d of the bottom wall 92, and further, the upper end 102u of the opening 102 is at a higher position than the upper end 92u of the bottom wall 92.

More specifically, the battery case 78 is inclined in a manner so that it becomes higher in position from the front toward the rear of the pedestal 12. Stated otherwise, the battery case 78 is formed in a rearwardly inclined posture in which the opening 102 is spaced apart from the drum 58. Accordingly, the accommodation hole 90 is inclined from the upper side in the vertical direction toward the rear side. Therefore, the insertion and removal direction, which is the axial line of the accommodation hole 90, is inclined rearwardly at an angle θ with respect to the horizontal direction. This angle θ is preferably 10 degrees to 45 degrees. By the angle θ being set to lie within such a range, attachment and detachment of the attachable and detachable battery 82 with respect to the accommodation hole 90 is easily performed.

Moreover, concerning the lower end 102d of the opening 102 and the upper end 92u of the bottom wall 92, it is sufficient if one of them is at a lower position and the other of them is at a higher position. More specifically, as shown in FIG. 1 and FIG. 3, the upper end 92u of the bottom wall 92 may be placed at a higher position than the lower end 102d of the opening 102. Conversely thereto, the lower end 102d of the opening 102 may also be placed at a higher position than the upper end 92u of the bottom wall 92.

The bottom wall 92 is perpendicular with respect to the lower wall 94, the left side wall 96, the right side wall 98, and the upper wall 100. As will be discussed later, the bottom wall 92 is a wall portion that blocks and holds back the attachable and detachable battery 82 that is inserted into the accommodation hole 90. A second connector 110 of a male type is provided on the bottom wall 92 at a location in close proximity to the upper wall 100. A first end of a harness 112 is connected to the second connector 110. A second end of the harness 112 is passed through a non-illustrated through hole formed in the bottom wall 92, and is electrically connected with respect to the motor 80. Accordingly, by the second connector 110 being engaged with the first connector 88, the attachable and detachable battery 82 and the motor 80 are electrically connected via the harness 112. Moreover, although illustration thereof is omitted, the harness 112 is connected to the motor 80 via an electrical current converter.

The motor 80 is supported by a non-illustrated support portion provided inside the storage box 72. In this state, the motor 80 is disposed upwardly of the battery case 78, and further, adjacent to the battery case 78. According to the first embodiment, the axial direction of the motor 80, for example, substantially coincides with the front-rear direction. Stated otherwise, in this case, the motor 80 extends in the horizontal direction. Further, a lower surface 80d of the motor 80 is at a higher position than the opening 102 of the battery case 78. Furthermore, at a time when the input opening 70 is at its highest position (when the drum 58 is in an upright posture facing vertically upward), the motor 80 is positioned at a lower position than the input opening 70. In FIG. 1, there are shown a virtual horizontal line VM passing through the lower surface 80d of the motor 80 and a virtual horizontal line VN passing through the input opening 70 that is at the highest position.

The motor 80 has a stator including an electromagnetic coil, and a rotor including a permanent magnet. Since the configuration thereof is well-known, detailed illustration and explanation of the motor will be omitted. The second connector 110 is electrically connected via the harness 112 to the electromagnetic coil. From the fact that the battery case 78 is adjacent to the motor 80, the second connector 110 is in close proximity to the motor 80. Therefore, the harness 112 can be made shorter in length.

The motor 80 includes a drive shaft 114 that extends toward the front. The drive shaft 114 is passed through the insertion hole 38 that is formed in the second tilting shaft 34r. A second rotating gear 116 is provided at a front end of the drive shaft 114 that is exposed from a front opening of the insertion hole 38. This second rotating gear 116 meshes with the first rotating gear 68 provided on the lower surface of the flange portion 66 of the drum 58.

Although illustration thereof is omitted, an ON switch and an OFF switch are provided in close proximity to the storage box 72. By the worker WK pressing the ON switch, the motor 80 is energized and the drive shaft 114 rotates. Further, by the worker WK pressing the OFF switch, the motor 80 is stopped and the rotation of the drive shaft 114 is then stopped.

Next, a description will be given concerning the actions and advantageous effects of the above-described first pot-type kneading machine 10.

Initially, the worker WK puts the material to be kneaded P into a drum 58 through the input opening 70. Moreover, as a typical example of the material to be kneaded P, there may be cited materials for mortar. More specifically, the material to be kneaded P, for example, includes water, sand, cement, and the like. Alternatively, in addition thereto, the material to be kneaded P may further include gravel, that is, material for concrete may be used as the material to be kneaded P.

At a time when the aforementioned material to be kneaded P is put into the drum 58, the drum 58 is placed in an inclined posture with the input opening 70 facing more upwardly than horizontally. Consequently, the material to be kneaded P is prevented from falling out from the input opening 70. In addition, it is easy for the material to be kneaded P to be put into the drum 58. The drum 58 may also be placed in an upright posture with the input opening 70 facing vertically upward.

After input of the material to be kneaded P into the drum 58 has been completed, as long as there is no need to adjust the angle of inclination of the drum 58, the worker WK presses the ON switch. In accordance therewith, electrical power is supplied from the attachable and detachable battery 82 to the electromagnetic coil of the motor 80. As a result, driving of the motor 80 is initiated, and the drive shaft 114 and the second rotating gear 116 rotate together in an integral manner.

The first rotating gear 68 meshes with the second rotating gear 116. As has been described above, the first rotating gear 68 is provided on the lower surface of the flange portion 66 of the drum 58. Accordingly, accompanying the rotation of the second rotating gear 116, the drum 58 rotates about the support shaft 50. Upon doing so, accompanying the rotation of the drum 58 in this manner, the material to be kneaded P inside the drum 58 is stirred by the stirring blade. More specifically, kneading is carried out with respect to the material to be kneaded P.

At a time when the material to be kneaded P is put into the drum 58, and when the drum 58 is made to rotate, dust is generated particularly in close proximity to the input opening 70. In this instance, in the storage box 72, the box main body 74 is supported in a predetermined posture by the rear columnar portion 22. The predetermined posture is a posture in which the open end faces in an opposite direction to the direction in which the drum 58 is disposed. In addition, the open end is closed by the lid body 76. Accordingly, it is difficult for the dust to reach the battery case 78. Therefore, the battery case 78 and the attachable and detachable battery 82 are protected from dust.

The same applies in relation to water as well. More specifically, even if water splashes out from the input opening 70 of the drum 58, it is difficult for such water to reach the battery case 78. Therefore, the battery case 78 and the attachable and detachable battery 82 are prevented from being exposed to water. Consequently, short circuiting, electrical leakage, or the like is prevented from occurring.

After a sufficient period of time has elapsed since stirring of the material to be kneaded P inside the drum 58 was started, the operator WK presses the OFF switch. Consequently, the supply of electrical power from the attachable and detachable battery 82 to the electromagnetic coil is stopped. As a result, the motor 80 is stopped, and the rotation of the drive shaft 114 and the second rotating gear 116 is stopped. Moreover, it should be noted that it is also possible to provide an OFF timer, and to automatically stop the motor 80 after a predetermined time period has elapsed.

Next, the worker WK transfers the material to be kneaded P into a vat 120 (refer to FIG. 4) or the like. For this purpose, the worker WK changes the posture of the drum 58 into an inclined posture in which the input opening 70 faces more downwardly than horizontally, as shown in FIG. 4. Moreover, the drum 58 may also be placed in an inverted position with the input opening 70 facing vertically downward.

Specifically, after having released the lock mechanism, the worker WK turns the angle adjustment handle 40. Accompanying the turning of the angle adjustment handle 40, the rotating shaft 41 and the first tilting gear 42, which are provided on the outer periphery of the rotating shaft 41, rotate. Furthermore, the second tilting gear 44, which meshes with the first tilting gear 42, is driven to rotate. From the fact that the second tilting gear 44 is provided on the outer periphery of the first tilting shaft 34f, the U-shaped member 16 rotates (tilts) about the first tilting shaft 34f and the second tilting shaft 34r.

The number of rotations of the rotating shaft 41 and the first tilting gear 42 corresponds to the number of rotations of the angle adjustment handle 40. Accordingly, as the number of rotations of the angle adjustment handle 40 increases, the number of rotations of the rotating shaft 41, the first tilting gear 42, and the second tilting gear 44 becomes greater. As a result, the angle of inclination of the drum 58 with respect to the horizontal direction becomes greater. Consequently, the drum 58 is placed in an inclined posture with the input opening 70 facing more downwardly than horizontally. Therefore, it becomes easy to take out the material to be kneaded P into the vat 120 via the input opening 70.

Moreover, it should be noted that the storage box 72 in which the battery case 78 is accommodated is positioned and fixed to the rear columnar portion 22. Thus, even if the angle of inclination of the drum 58 changes, the angle of inclination of the battery case 78 and the angle of inclination of the attachable and detachable battery 82 do not accordingly change. Similarly, the angle of inclination of the motor 80 does not change.

At a time when the remaining charge capacity (state of charge: SOC) of the attachable and detachable battery 82 has decreased, the attachable and detachable battery 82 is replaced by the worker WK with a newly charged attachable and detachable battery 82. Such a replacement operation is carried out, for example, after a new attachable and detachable battery 82 has been transported to a location where the first pot-type kneading machine 10 has been set down. Alternatively, the worker WK may transport the first pot-type kneading machine 10 to a location where the new attachable and detachable battery 82 has been set down, and may thereafter carry out replacement of the attachable and detachable battery 82.

At the time when replacement of the attachable and detachable battery 82 is carried out, the worker WK goes around to the rear of the first pot-type kneading machine 10, causes the lid body 76 to rotate, and places the box main body 74 in an open state. Consequently, the worker WK is capable of visually recognizing the battery case 78.

Next, the worker WK grasps the handle portion 84 of the attachable and detachable battery 82 inside the accommodation hole 90, and pulls the attachable and detachable battery 82 upwardly toward a higher position in the rearward direction. From the fact that the lower wall 94 that forms the accommodation hole 90 is inclined, the lower wall 94 bears a portion of the weight of the attachable and detachable battery 82. Accordingly, at a time when the worker WK pulls the attachable and detachable battery 82 upwardly from the accommodation hole 90, the lower wall 94 bears the load of the attachable and detachable battery 82. Therefore, the force required when the worker WK pulls the attachable and detachable battery 82 upwardly from the accommodation hole 90 can be made smaller in comparison to a case in which the accommodation hole 90 extends along the vertical direction.

Further, the battery case 78 is inclined at a predetermined posture. The predetermined posture is a posture in which the direction in which the attachable and detachable battery 82 is inserted and removed (see FIG. 3) is inclined in a direction away from the drum 58. Accordingly, the attachable and detachable battery 82, which moves accompanying the removal thereof, does not interfere with the drum 58, the pedestal 12, or the like. Therefore, the attachable and detachable battery 82 can be easily made to separate away from the battery case 78.

Next, the worker WK accommodates a new attachable and detachable battery 82 into the accommodation hole 90 of the battery case 78. For this purpose, the worker WK grasps the handle portion 84 of the new attachable and detachable battery 82 and lifts up the attachable and detachable battery 82. Furthermore, the worker WK holds the attachable and detachable battery 82 in an inclined posture in which the bottom surface 86 is placed at a slightly lower position and the handle portion 84 is placed at a slightly higher position.

Thereafter, the worker WK causes one side surface of the attachable and detachable battery 82 to be placed in abutment with the lower wall 94 that forms the accommodation hole 90. Furthermore, the attachable and detachable battery 82 is made to slide along the lower wall 94 from this state toward the bottom wall 92, and then the bottom surface 86 of the attachable and detachable battery 82 comes into abutment with the bottom wall 92 of the accommodation hole 90. Along therewith, the attachable and detachable battery 82 is supported by the battery case 78. Further, the first connector 88 provided on the bottom surface 86 of the attachable and detachable battery 82 and the second connector 110 provided on the bottom wall 92 of the battery case 78 engage with each other.

The lower wall 94 is inclined with respect to the vertical direction and the horizontal direction in a manner so as to become lower toward the bottom wall 92. Therefore, the attachable and detachable battery 82 easily slides on the lower wall 94 due to its own weight. Accordingly, the force required when the worker WK pushes the attachable and detachable battery 82 into the accommodation hole 90 can be made smaller in comparison to a case in which the accommodation hole 90 extends along the horizontal direction. In this manner, the lower wall 94 is inclined with respect to the horizontal direction and the vertical direction. Therefore, both at the time when the attachable and detachable battery 82 is taken out from the battery case 78, as well as when the attachable and detachable battery 82 is accommodated in the battery case 78, it is easy for the attachable and detachable battery 82 to be made to slide along the lower wall 94.

In addition, the position where the opening 102 of the battery case 78 is provided is at a higher position than the upper end of each of the left vehicle wheel 28L and the right vehicle wheel 28R (the virtual horizontal line VL shown in FIG. 1). Therefore, at the time when the attachable and detachable battery 82 is attached and detached, there is no need for the worker WK to excessively bend at the waist, knees, or the like. Further, the opening 102 of the battery case 78 is at a lower position than the highest position of the input opening 70 (the virtual horizontal line VN shown in FIG. 1), and further, at a lower position than the lower surface 80d of the motor 80 (the virtual horizontal line VM shown in FIG. 1). Therefore, the amount by which the battery case 78 is lifted up from the ground surface G becomes smaller. For the reasons mentioned above, the burden on the worker WK is reduced. Furthermore, the operation of replacing the attachable and detachable battery 82 becomes easier.

After having completed the replacement of the attachable and detachable battery 82 in the manner described above, the worker WK rotates the lid body 76 and thereby closes the box main body 74. Consequently, the attachable and detachable battery 82 that is accommodated in the accommodation hole 90 is shielded by the lid body 76 along with the battery case 78. From then on, the worker WK performs the kneading operation in the same manner as described previously.

In the case that the first pot-type kneading machine 10 is made to move, the worker WK lifts up the towing bar 23. In accordance therewith, the pedestal 12 is inclined about the left vehicle wheel 28L and the right vehicle wheel 28R, in a manner so that the lower end surface of the front columnar portion 20 is spaced apart from the ground surface G. Next, the worker WK hooks a hook or the like of a towing vehicle onto the ring portion 24 of the towing bar 23. In this state, by the towing vehicle moving toward the front, the first pot-type kneading machine 10 advances toward the front. After the towing vehicle and the first pot-type kneading machine 10 have arrived at a desired location, the hook or the like of the towing vehicle is removed from the towing bar 23.

Alternatively, after the worker WK faces rearward and lifts up the towing bar 23, then in such a state, the worker WK may walk toward the rear. In this case, the first pot-type kneading machine 10 advances toward the rear.

Moreover, it should be noted that a pair of vehicle wheels may also be provided on a lower end of the front columnar portion 20 in the same manner as on the rear columnar portion 22. In this case, it becomes unnecessary for the worker WK to lift up the towing bar 23.

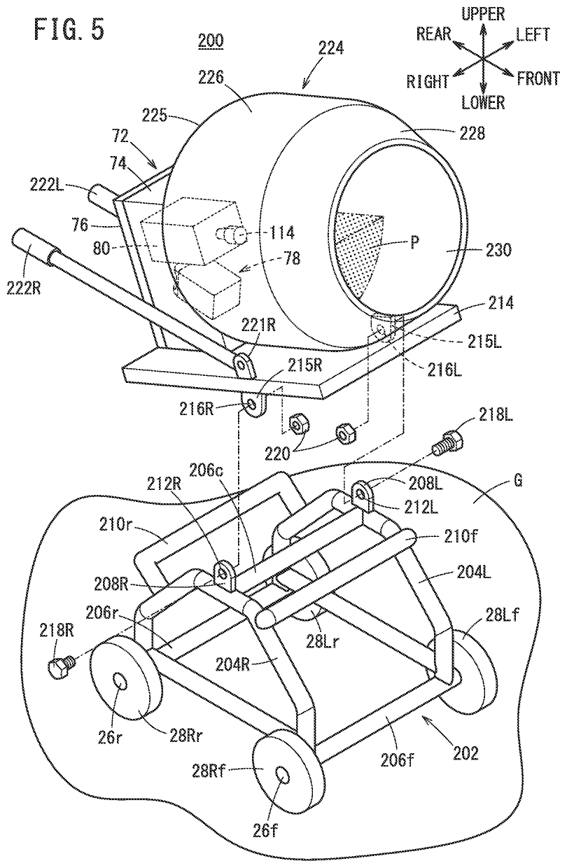

Next, with reference to FIG. 5 to FIG. 8, a description will be given concerning a second pot-type kneading machine 200 according to a second embodiment of the present invention. Moreover, in the second embodiment, a direction in which an input opening 230 of a drum 224 of the second pot-type kneading machine 200 faces is defined as a “front”, and a direction in which a left bar-shaped handle 222L and a right bar-shaped handle 222R are provided is defined as a “rear”. Further, each of the terms “left” and “right” refers respectively to a leftward direction and a rightward direction when a worker WK views the second pot-type kneading machine 200 from the rear to the front thereof. Furthermore, the definitions for “higher position” and “lower position” are the same as in the first embodiment.

The same reference numerals are applied to constituent elements that are the same as or correspond to the constituent elements in the first embodiment and that do not particularly need to be distinguished from the constituent elements of the first embodiment. Further, the worker WK is not shown in FIG. 5 to FIG. 8.

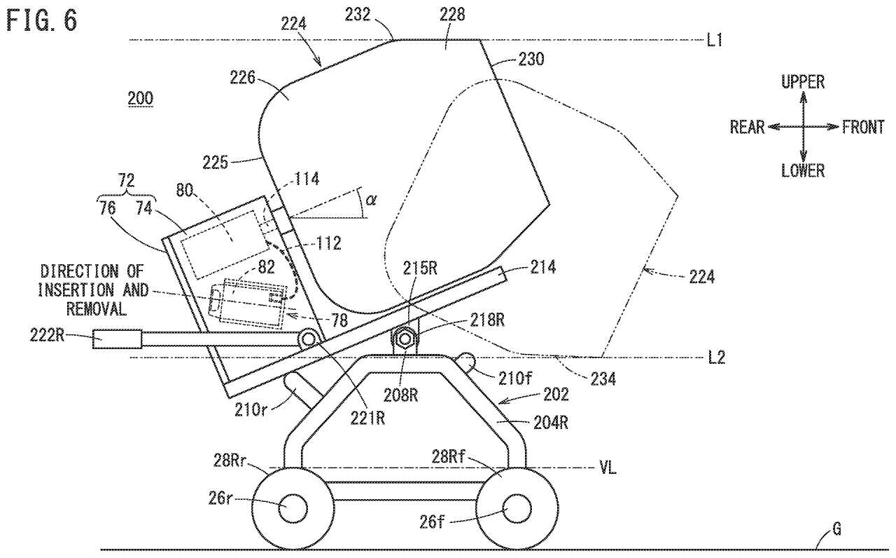

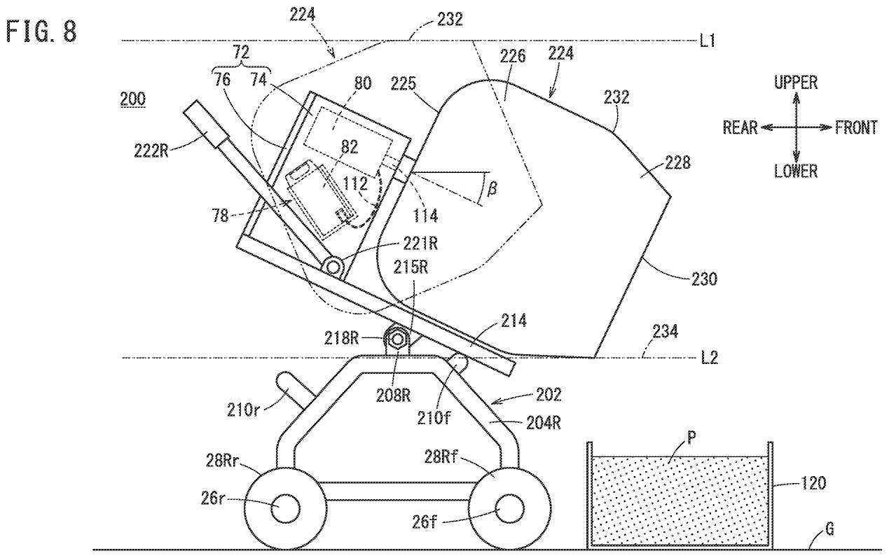

The second pot-type kneading machine 200 includes a pedestal 202. A left portion and a right portion of the pedestal 202 are a left triangular frame portion 204L and a right triangular frame portion 204R, respectively, which exhibit a substantially triangular ring shape when viewed from the side. Moreover, in FIGS. 6 and 8, the left triangular frame portion 204L on the left side overlaps with the right triangular frame portion 204R.

As can be understood from FIG. 5, a front hollow beam portion 206f, a rear hollow beam portion 206r, and an upper hollow beam portion 206c are bridged between the left triangular frame portion 204L and the right triangular frame portion 204R. A distance from the upper hollow beam portion 206c to the front hollow beam portion 206f, and a distance from the upper hollow beam portion 206c to the rear hollow beam portion 206r are substantially equivalent to each other.

The front hollow beam portion 206f is disposed between the front lower vertex portions of the left triangular frame portion 204L and the right triangular frame portion 204R. A front connecting shaft 26f is rotatably passed through the front hollow beam portion 206f. The left end and the right end of the front connecting shaft 26f are exposed from the front hollow beam portion 206f. A left front vehicle wheel 28Lf and a right front vehicle wheel 28Rf are retained on the left end and the right end.

In the same manner, the rear hollow beam portion 206r is disposed between the rear lower vertex portions of the left triangular frame portion 204L and the right triangular frame portion 204R. A rear connecting shaft 26r is rotatably passed through the rear hollow beam portion 206r. The left end and the right end of the rear connecting shaft 26r are exposed from the rear hollow beam portion 206r. A left rear vehicle wheel 28Lr and a right rear vehicle wheel 28Rr are retained at the left end and the right end. In FIG. 6 and FIG. 8, the left front vehicle wheel 28Lf and the left rear vehicle wheel 28Lr overlaps respectively with the right front vehicle wheel 28Rf and the right rear vehicle wheel 28Rr.

In this instance, a left lower tongue portion 208L and a right lower tongue portion 208R are provided respectively at the highest vertex portions of the left triangular frame portion 204L and the right triangular frame portion 204R (refer in particular to FIG. 5). The upper hollow beam portion 206c is bridged across from the left lower tongue portion 208L to the right lower tongue portion 208R. Further, a front stopper portion 210f is bridged between the front portions of the left triangular frame portion 204L and the right triangular frame portion 204R. Furthermore, a rear stopper portion 210r is bridged between the rear portions of the left triangular frame portion 204L and the right triangular frame portion 204R. The front stopper portion 210f is at a higher position than the rear stopper portion 210r.

In the left lower tongue portion 208L, a left lower insertion hole 212L which penetrates along a thickness direction (a left-right direction) is formed more upwardly than a portion where the upper hollow beam portion 206c is provided. Similarly, in the right lower tongue portion 208R as well, a right lower insertion hole 212R which penetrates along the thickness direction (the left-right direction) is formed more upwardly than a portion where the upper hollow beam portion 206c is provided.

The pedestal 202 further includes a flat plate-shaped tilting plate 214. A left upper tongue portion 215L and a right upper tongue portion 215R are provided on a lower surface of the tilting plate 214 in a manner so as to project downward. Further, a left upper insertion hole 216L which penetrates along the thickness direction (the left-right direction) is formed in the left upper tongue portion 215L. A right upper insertion hole 216R which penetrates along the thickness direction (the left-right direction) is formed in the right upper tongue portion 215R. The diameters of the left lower insertion hole 212L, the right lower insertion hole 212R, the left upper insertion hole 216L, and the right upper insertion hole 216R are substantially equivalent to each other.

The left upper insertion hole 216L is overlapped with the left lower insertion hole 212L. A left tilting shaft 218L is inserted through the left lower insertion hole 212L and the left upper insertion hole 216L. Similarly, the right upper insertion hole 216R is overlapped with the right lower insertion hole 212R. A right tilting shaft 218R is inserted through the right lower insertion hole 212R and the right upper insertion hole 216R. The left tilting shaft 218L and the right tilting shaft 218R are made up from, for example, bolts having a slightly smaller diameter than the left lower insertion hole 212L, the left upper insertion hole 216L, the right lower insertion hole 212R, and the right upper insertion hole 216R. In this case, nuts are screw-engaged onto the bolts as retaining members 220.

A right stay 221R is provided on an upper surface of a right end portion of the tilting plate 214. The right bar-shaped handle 222R is connected to the right stay 221R. The right bar-shaped handle 222R extends rearwardly from the right stay 221R. Further, a non-illustrated left stay is provided on an upper surface of a left end portion of the tilting plate 214. The left bar-shaped handle 222L is connected to the left stay. The left bar-shaped handle 222L extends rearwardly from the left stay. At a time of being in a natural state in which no force is being applied to lift up the tilting plate 214, as shown in FIG. 6, the left bar-shaped handle 222L and the right bar-shaped handle 222R become approximately horizontal. At a time when the worker WK tilts the tilting plate 214 together with the drum 224, and at a time when causing the second pot-type kneading machine 200 to advance or the like, the left bar-shaped handle 222L and the right bar-shaped handle 222R are gripped by the worker WK.

On a rear portion of the tilting plate 214, the storage box 72 is disposed at a position sandwiched between the left bar-shaped handle 222L and the right bar-shaped handle 222R. Similar to the first embodiment, the storage box 72 includes the box main body 74 having a rectangular tubular shape, and the lid body 76 that is connected via a non-illustrated hinge to the box main body 74. The lid body 76 opens and closes an open end at the rear end of the box main body 74. In this manner, in the second embodiment as well, the box main body 74 is supported in a predetermined posture by the tilting plate 214. The predetermined posture is a posture in which the open end faces in an opposite direction to the direction in which the drum 224 is disposed (a posture in which the open end does not face toward the drum 224).

The battery case 78, which is an attachable and detachable battery accommodating portion, and the motor 80 are accommodated in an inner chamber that is formed in the box main body 74. The box main body 74 is at a higher position than the rear connecting shaft 26r, and upper ends of the left rear vehicle wheel 28Lr and the right rear vehicle wheel 28Rr. Therefore, the battery case 78 is also at a higher position than the rear connecting shaft 26r, and the upper ends of the left rear vehicle wheel 28Lr and the right rear vehicle wheel 28Rr. Further, the rear end of the battery case 78 is positioned upwardly of the left rear vehicle wheel 28Lr and the right rear vehicle wheel 28Rr. Moreover, a virtual horizontal line VL shown in FIG. 6 indicates the upper ends of the left rear vehicle wheel 28Lr and the right rear vehicle wheel 28Rr.

The configuration of each of the battery case 78 and the attachable and detachable battery 82 is the same as that in the first embodiment. Therefore, the same reference numerals as in the first embodiment concerning the battery case 78 and the attachable and detachable battery 82 are used, and detailed description of these reference numerals will be omitted. Moreover, it should be noted that the positional relationship between the battery case 78 and the motor 80 inside the storage box 72 is also the same as that in the first embodiment.

The battery case 78, the attachable and detachable battery 82, and the motor 80 are considerably heavy objects. Therefore, in the aforementioned natural state, as shown in FIG. 6, the rear end of the tilting plate 214 comes into abutment with the rear stopper portion 210r. More specifically, in the natural state, the tilting plate 214 is positioned at a rearward ending point. Further, in the natural state, the battery case 78 is inclined in a manner such that the rear end is at an upper position end and the front end is at a lower position.

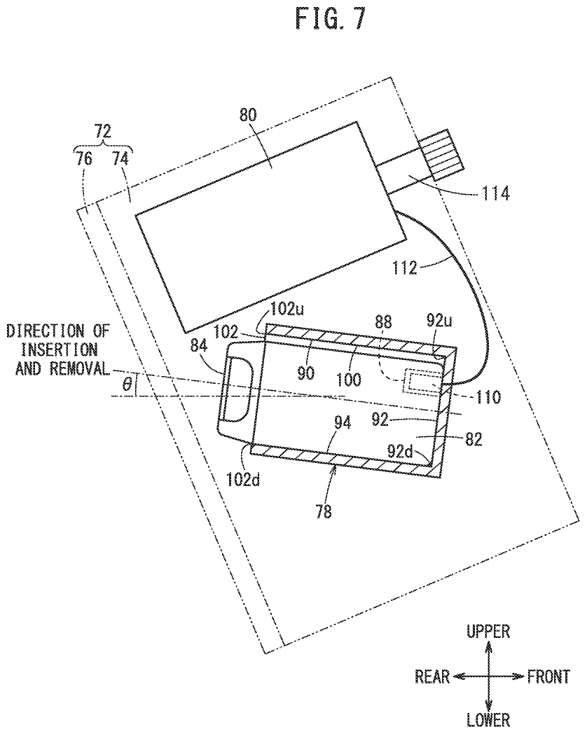

As shown in detail in FIG. 7, the opening 102 of the battery case 78 faces rearward. Accordingly, the bottom wall 92 faces toward a closed bottom portion 225 of the drum 224. In this manner, in the second pot-type kneading machine 200, the opening 102 of the battery case 78 is positioned in an opposite direction to the drum 224. Therefore, the direction in which the attachable and detachable battery 82 is inserted into and removed from the accommodation hole 90 (i.e., the direction in which the opening 102 of the battery case 78 faces) is inclined toward a direction away from the input opening 230 of the drum 224. In this manner, the opening 102 does not face toward the drum 224. More specifically, the battery case 78 is accommodated in the box main body 74 in a state of being at the predetermined inclined posture. The predetermined inclined posture is defined as a posture other than a posture in which the opening 102 faces toward the drum 224.

In this case, the lower end 102d of the opening 102 is positioned further rearward than the upper end 102u of the opening 102. Further, the lower end 92d of the bottom wall 92 is positioned further rearward than the upper end 92u of the bottom wall 92. The lower ends 92d and 102d are at a lower position than the upper ends 92u and 102u. More specifically, the battery case 78 is inclined in a manner so that it becomes higher in position from the front toward the rear of the pedestal 202. Accordingly, the accommodation hole 90 is rearwardly inclined from the upper side in the vertical direction toward the rear side. Therefore, the insertion and removal direction, which is the axial line of the accommodation hole 90, is inclined rearwardly at an angle θ with respect to the horizontal direction.

The angle θ, in the same manner as in the first embodiment, is preferably 10 degrees to 45 degrees. As noted previously, by the angle θ being set to lie within such a range, attachment and detachment of the attachable and detachable battery 82 with respect to the accommodation hole 90 is easily performed. Moreover, as shown in FIG. 7, the lower end 102d of the opening 102 may also be placed at a higher position than the upper end 92u of the bottom wall 92. Conversely thereto, the lower end 102d of the opening 102 may also be placed at a lower position than the upper end 92u of the bottom wall 92.

The second connector 110 is provided on the bottom wall 92 at a location in close proximity to the upper wall 100. The first end of the harness 112 is connected to the second connector 110. The second end of the harness 112 is passed through a non-illustrated through hole formed in the bottom wall 92, and is connected to the motor 80.

The motor 80 is disposed upwardly of the battery case 78, in a state of being supported by a non-illustrated support portion provided inside the box main body 74. In its natural state, the motor 80 is placed in an inclined posture, for example, with the front end thereof at a higher position and the rear end thereof at a lower position. More specifically, the direction of inclination of the motor 80 is opposite to the direction of inclination of the battery case 78. The motor 80 includes the drive shaft 114 (refer to FIG. 6 to FIG. 8). In the same manner as the motor 80, the drive shaft 114 is inclined in a manner so that it becomes lower in position from the front toward the rear. At this time, an angle of intersection α between the drive shaft 114 and the horizontal direction lies within a range of 15 degrees to 30 degrees.

A male screw portion is provided on the front end of the drive shaft 114. Further, a non-illustrated female screw portion is formed in the closed bottom portion 225 (the closed wall) of the drum 224. The male screw portion extends from the front wall of the box main body 74, and is screwed-engaged with the female screw portion. Via this screw-engagement, the drum 224 is connected to the drive shaft 114. In this manner, the drum 224 is supported by the motor 80 via the drive shaft 114. In this instance, the motor 80 is supported by the tilting plate 214 via the storage box 72. Accordingly, the drum 224 is indirectly supported by the tilting plate 214 via the motor 80 and the storage box 72. Moreover, it should be noted that the drum 224 is not in contact with the tilting plate 214.

As can be understood from the foregoing, in the second pot-type kneading machine 200, the drive shaft 114 and the drum 224 rotate together in an integral manner.

Although illustration thereof is omitted, an ON switch and an OFF switch are provided in close proximity to the storage box 72. By the worker WK pressing the ON switch, the motor 80 is energized and the drive shaft 114 rotates. Further, by the worker WK pressing the OFF switch, the motor 80 is stopped and the rotation of the drive shaft 114 is stopped accordingly.

The drum 224 is a hollow body made up from a bottomed cup portion 226 having an approximately constant inner diameter, and a tapered tubular portion 228 that is connected to the cup portion 226 and reduces in diameter in a tapered shape. The input opening 230, which serves for the purpose of putting the material to be kneaded P into the drum 224, is formed at a distal end of the tapered tubular portion 228 which is smallest in diameter. The drum 224 in its natural state is in an inclined posture with the input opening 230 facing more upwardly than horizontally. Accordingly, at a time when the material to be kneaded P is accommodated in the drum 224 which is in its natural state (in an ascended posture), the material to be kneaded P is stored in a corner portion of the cup portion 226 that is at a lowest position.

Moreover, it should be noted that the reference numeral 232 in FIG. 6 and FIG. 8 indicates a highest position of the drum 224 in its natural state. Further, the reference numeral 234 indicates a lowest position of the drum 224 in a state of discharging, which will be described later. Furthermore, the reference numeral L1 denotes a virtual upper horizontal line that passes through the highest position 232 of the drum 224 and extends along the horizontal direction. The reference numeral L2 denotes a virtual lower horizontal line that passes through the lowest position 234 of the drum 224 and extends along the horizontal direction.

A non-illustrated stirring blade is provided on an inner wall of the drum 224. Accompanying the rotation of the drum 224, the stirring blade rotates integrally together with the drum 224.

Next, a description will be given concerning the actions and advantageous effects of the above-described second pot-type kneading machine 200.

Initially, in the natural state shown in FIG. 6, the worker WK puts the material to be kneaded P into the drum 224 through the input opening 230. The drum 224 in its natural state is in an inclined posture with the input opening 230 facing more upwardly than horizontally. Accordingly, the material to be kneaded P is prevented from falling out from the input opening 230. Further, it is easy for the material to be kneaded P to be put into the drum 224. Moreover, as a typical example of the material to be kneaded P, there may be cited material for mortar or material for concrete.

After inputting of the material to be kneaded P into the drum 224 has been completed, the worker WK presses the ON switch. In accordance therewith, electrical power is supplied from the attachable and detachable battery 82 to the electromagnetic coil of the motor 80. As a result, driving of the motor 80 is initiated and the drive shaft 114 rotates.

Accompanying the rotation of the drive shaft 114, the drum 224 rotates integrally together with the drive shaft 114 about the drive shaft 114. Further, the material to be kneaded P inside the drum 224 is stirred by the stirring blade. More specifically, kneading is carried out with respect to the material to be kneaded P.

At a time when the material to be kneaded P is put into the drum 224, and when the drum 224 is made to rotate, dust is generated particularly in close proximity to the input opening 230. In this instance, the storage box 72 is supported by the tilting plate 214 in a posture such that the open end of the box main body 74 faces in an opposite direction to the drum 224. In addition, the open end is closed by the lid body 76. Accordingly, it is difficult for the dust to reach the battery case 78. The same also applies to water that is used when kneading mortar or concrete. Therefore, the battery case 78 and the attachable and detachable battery 82 are protected from dust, water, or the like.

After a sufficient period of time has elapsed since stirring of the material to be kneaded P inside the drum 224 was started, the worker WK presses the OFF switch. Consequently, the supply of electrical power from the attachable and detachable battery 82 to the electromagnetic coil is stopped. As a result, the motor 80 is stopped, and the rotation of the drive shaft 114 and the drum 224 is stopped.

Next, the worker WK transfers the material to be kneaded P into a vat 120 (refer to FIG. 8) or the like. For this purpose, the worker WK places the drum 224 in a state of discharging in which the input opening 230 faces more downwardly than horizontally, as shown in FIG. 8.

Specifically, after the worker WK has grasped the rear ends of the left bar-shaped handle 222L and the right bar-shaped handle 222R, the worker WK lifts up the left bar-shaped handle 222L and the right bar-shaped handle 222R in a manner so that the rear ends rise upwardly. As a result, as shown in FIG. 8, the tilting plate 214 becomes placed in an inclined position with the front at a lower position and with the rear at an upper position. The center about which the tilting plate 214 is tilted is the left tilting shaft 218L and the right tilting shaft 218R. The rotation of the tilting plate 214 and the drum 224 is stopped by the tilting plate 214 coming into abutment with the front stopper portion 210f. At this time, the tilting plate 214 and the drum 224 are positioned at a frontward ending point.

The storage box 72 is supported by the tilting plate 214. Further, the motor 80 inside the storage box 72 supports the drum 224 via the drive shaft 114. Accordingly, as a result of the tilting plate 214 rotating in the manner described above, the drum 224 becomes placed in a state of discharging in which the input opening 230 at the front end faces more downwardly than horizontally. Therefore, it becomes easy to take out the material to be kneaded P to the exterior of the drum 224 via the input opening 230.

In this instance, the storage box 72 in which the battery case 78 is accommodated rotates integrally with the tilting plate 214, in a manner so as to move from a lower rear position to a higher front position. More specifically, in this case, the angle of inclination of the battery case 78 and the attachable and detachable battery 82 change by following the changes in the angle of inclination of the tilting plate 214 and the drum 224. As can be understood from FIG. 6 and FIG. 8, the range of movement of the battery case 78 and the attachable and detachable battery 82 lies between the virtual upper horizontal line L1 and the virtual lower horizontal line L2.

Further, the motor 80 also rotates in the same manner as the battery case 78. At a time when the tilting plate 214 and the drum 224 are positioned at the frontward ending point, an angle of intersection β between the drive shaft 114 and the horizontal direction is typically 15 degrees to 30 degrees. In this case as well, the lower end 92d of the bottom wall 92 of the battery case 78 is at a lower position than the lower end 102d of the opening 102.

At a time when the SOC of the attachable and detachable battery 82 has decreased, the attachable and detachable battery 82 is replaced by the worker WK with a newly charged attachable and detachable battery 82. Such a replacement operation is carried out, for example, after the new attachable and detachable battery 82 has been transported to a location where the second pot-type kneading machine 200 has been set down. Alternatively, the worker WK may transport the second pot-type kneading machine 200 to a location where the new attachable and detachable battery 82 has been set down, and may thereafter carry out replacement of the attachable and detachable battery 82.

At the time of replacing the attachable and detachable battery 82, the worker WK goes around to the rear of the second pot-type kneading machine 200. At this point in time, since the worker WK has not lifted up the left bar-shaped handle 222L and the right bar-shaped handle 222R, the tilting plate 214 and the drum 224 are in a natural state of being positioned at the rearward ending point (refer to FIG. 6). In this state, the worker WK rotates the lid body 76, and places the box main body 74 in an open state. Consequently, the worker WK is capable of visually recognizing the battery case 78.

Next, the worker WK grasps the handle portion 84 of the attachable and detachable battery 82 inside the accommodation hole 90, and pulls the attachable and detachable battery 82 upwardly toward a higher position in the rearward direction. For the same reason as in the first embodiment, the attachable and detachable battery 82 can easily be made to separate away from the battery case 78. In addition, according to the second embodiment, the range of movement of the battery case 78 and the attachable and detachable battery 82 lies between the virtual upper horizontal line L1 and the virtual lower horizontal line L2. Moreover, the battery case 78 is located at a higher position than the left front vehicle wheel 28Lf, the right front vehicle wheel 28Rf, the left rear vehicle wheel 28Lr, and the right rear vehicle wheel 28Rr. In this case, the height of the opening 102 from the ground surface G becomes appropriate. Accordingly, there is no need for the worker WK to excessively bend at the waist or knees. Accordingly, the burden on the worker WK can be reduced.

Thereafter, the worker WK lifts up the attachable and detachable battery 82 in the same manner as in the first embodiment, and furthermore, inserts the attachable and detachable battery 82 into the accommodation hole 90 from the opening 102. For the same reasons as noted previously, in the second embodiment as well, the operation of replacing the attachable and detachable battery 82 becomes easier.

After having completed the replacement of the attachable and detachable battery 82 in the manner described above, the operator WK rotates the lid body 76 and thereby closes the box main body 74. Consequently, the attachable and detachable battery 82 that is accommodated in the accommodation hole 90 is shielded by the lid body 76 along with the battery case 78. From then on, the worker WK performs the kneading operation in the same manner as described previously.

In the case that the second pot-type kneading machine 200 is made to move, the operator WK faces forward and grasps the rear ends of the left bar-shaped handle 222L and the right bar-shaped handle 222R. Thereafter, the worker walks in the frontward direction. Consequently, the second pot-type kneading machine 200 is pushed toward the front. More specifically, together with rotating the left rear vehicle wheel 28Lr, the right rear vehicle wheel 28Rr, the left front vehicle wheel 28Lf, and the right front vehicle wheel 28Rf from the rear toward the front, the second pot-type kneading machine 200 advances.

As has been described above, the present embodiment is characterized by the kneading machine (10) equipped with the drum (58) configured to accommodate the material to be kneaded (P), the stirring member configured to stir the material to be kneaded inside the drum, and the motor (80) configured to rotate the stirring member, the kneading machine including:
the battery case (78) configured to accommodate the attachable and detachable battery (82) configured to supply electrical power to the motor; and
the pedestal (12) configured to support the drum;
wherein the input opening (70) through which inputting of the material to be kneaded is performed is formed in the drum;
the accommodation portion (90) configured to accommodate the attachable and detachable battery is formed in the battery case, and the opening (102) through which the attachable and detachable battery is inserted or removed is formed in the accommodation portion; and
the battery case is retained in a state in which the opening of the battery case is placed in a posture other than a posture in which the opening of the battery case faces toward the drum.

In the case of supplying electrical power to the motor from a commercial electrical power source, the plug of an electrical power supply cable must be inserted into an outlet. Accordingly, the area within which the kneading machine is capable of being used is limited. Specifically, the usable area lies only within the range in which the plug is capable of being inserted into the outlet. In contrast to this limitation, in the above-described kneading machine, electrical power is supplied to the motor from an attachable and detachable battery. Accordingly, it is possible to use the kneading machine, even in locations other than in the vicinity of a commercial electrical power source. In other words, the range within which the kneading machine is capable of being used is expanded.

Further, in the kneading machine, at a time when the material to be kneaded is put thereinto through the input opening, and when the material to be kneaded is stirred, dust is likely to be generated in close proximity to the input opening. In this instance, according to the present invention, the opening of the battery case is placed in a posture other than in a posture facing toward the drum. More specifically, the opening does not face toward the drum. Therefore, the battery case and the attachable and detachable battery can be protected from dust.

The battery case is preferably positioned and fixed to the pedestal in a predetermined inclined posture. The predetermined inclined posture is a posture in which the lower end (92d) of the bottom wall (92) of the accommodation portion is at a lower position than the lower end (102d) of the opening of the battery case. When the battery case is placed in such an inclined posture, the accommodation portion is also inclined. Accordingly, a portion of the inner wall of the accommodation portion bears the weight of the attachable and detachable battery. Therefore, insertion and removal of the attachable and detachable battery is facilitated.

The bottom wall of the battery case is preferably disposed at a position facing toward the closed wall (60) of the drum. Dust almost never scatters away from the closed wall. Even if scattering of dust occurs, the amount of such dust is extremely small. Therefore, the battery case and the attachable and detachable battery can be further protected from dust.

The pedestal is preferably constructed in a manner so as to include the tilting shaft (34f, 34r). In this case, the drum is capable of being tilted about the tilting shaft. By the drum being made to tilt, for example, it becomes easy to discharge the material to be kneaded that is inside the drum.

The restricting portion configured to restrict the tilting of the drum is preferably provided. Further, the battery case and the drum are supported on the pedestal in a manner so as to rotate about the tilting shaft. In such a configuration, at a time when the rotation of the battery case is restricted by the restricting portion, the battery case is placed in a predetermined inclined posture. The predetermined inclined posture is a posture in which the lower end of the bottom wall is at a lower position than the lower end of the opening of the battery case.

In this case, at the same time that the drum is inclined, the battery case is also inclined. Accordingly, before and after being inclined, a situation is maintained in which the opening of the battery case does not face toward the input opening of the drum. Therefore, the battery case and the attachable and detachable battery are protected from dust that scatters out from the input opening.

The opening of the battery case is preferably provided between the highest position and the lowest position of the input opening at a time when the drum tilts about the tilting shaft. In this case, the position of the battery case is prevented from becoming excessively low and from becoming excessively high. Therefore, it is easy for the worker to attach and detach the attachable and detachable battery with respect to the battery case.

The pedestal is preferably provided with the vehicle wheels that is in contact with the ground surface. In this case, the battery case is disposed at a higher position than the vehicle wheels. Further, the motor is disposed at a higher position than the opening of the battery case and at a lower position than the highest position of the input opening of the drum. As a result, the battery case is positioned between the vehicle wheels and the motor which is at a lower position than the highest position of the input opening of the drum. By the battery case being positioned in this manner, the worker is capable of easily attaching and detaching the attachable and detachable battery with respect to the battery case.

The battery case and the motor are preferably adjacent to each other. In accordance with this feature, the length of the harness that connects the connector of the battery case and the motor can be made as small as possible.

As one suitable example of the kneading machine, there may be cited a pot-type kneading machine. In such a pot-type kneading machine, the drum also serves in a dual manner as the stirring member.

Moreover, it should be noted that the present invention is not limited to the above-described embodiment, and various configurations can be adopted therein without departing from the essence and gist of the present invention.

For example, there is no particular need for the lid body 76 to be included in the storage box 72. Further, there is no particular need to accommodate the battery case 78 in the storage box 72, and the battery case 78 may be directly supported by the pedestal 12 and 202. In this case, the battery case 78 preferably is provided with a lid member that opens and closes the opening 102.

Further, the present invention can also be applied to a so-called grout-type kneading machine. Such a grout-type kneading machine is equipped with a drum that is positioned and fixed, and a stirring blade that rotates in the interior of the drum. In such a configuration, the drive shaft 114 of the motor 80 is connected to the central shaft of the stirring blade. Accordingly, when the motor 80 receives electrical power from the attachable and detachable battery 82, the drive shaft 114 and the stirring blade rotate together in an integral manner.

### REFERENCE SIGNS LIST

10: first pot-type kneading machine
12, 202: pedestal
14: main frame
16: U-shaped member
23: towing bar
26, 26f, 26r: connecting shaft
28L, 28Lf, 28Lr, 28R, 28Rf, 28Rr: vehicle wheel
34f: first tilting shaft
34r: second tilting shaft
38: insertion hole
40: angle adjustment handle
41: rotating shaft
42: first tilting gear
44: second tilting gear
48: insertion hole
50: support shaft
58, 224: drum
60, 226: cup portion
62, 228: tapered tubular portion
64, 225: closed bottom portion
66: flange portion
68: first rotating gear
70, 230: input opening
72: storage box
78: battery case
80: motor
82: attachable and detachable battery
88: first connector
90: accommodation hole
92: bottom wall
94: lower wall
100: upper wall
102: opening
110: second connector
112: harness
114: drive shaft
116: second rotating gear
120: vat
200: second pot-type kneading machine
210f: front stopper portion
210r: rear stopper portion
214: tilting plate
218L: left tilting shaft
218R: right tilting shaft
222L: left bar-shaped handle
222R: right bar-shaped handle
232: highest position
234: lowest position
G: ground surface
P: material to be kneaded
WK: worker

1. A kneading machine comprising:
a drum configured to accommodate a material to be kneaded;
a stirring member configured to stir the material to be kneaded inside the drum;
a motor configured to rotate the stirring member;
a battery case configured to accommodate an attachable and detachable battery configured to supply electrical power to the motor; and
a pedestal configured to support the drum,
wherein an input opening through which inputting of the material to be kneaded is performed is formed in the drum;
an accommodation portion configured to accommodate the attachable and detachable battery is formed in the battery case, and an opening through which the attachable and detachable battery is inserted or removed is formed in the accommodation portion; and
the battery case is retained in a state in which the opening of the battery case is placed in a posture other than a posture in which the opening of the battery case faces toward the drum.

2. The kneading machine according to claim 1, wherein the battery case is positioned and fixed to the pedestal in an inclined posture in which a lower end of a bottom wall of the accommodation portion is at a lower position than a lower end of the opening of the battery case.

3. The kneading machine according to claim 1, wherein a bottom wall of the battery case is disposed at a position facing toward a closed wall of the drum.

4. The kneading machine according to claim 1, wherein the pedestal includes a tilting shaft, and
the drum is tiltable about the tilting shaft.

5. The kneading machine according to claim 4, further comprising a restricting portion configured to restrict tilting of the drum about the tilting shaft,
wherein the battery case and the drum are supported on the pedestal in a manner so as to rotate about the tilting shaft; and
when rotation of the battery case is restricted by the restricting portion, the battery case is placed in an inclined posture in which a lower end of a bottom wall of the battery case is at a lower position than a lower end of the opening of the battery case.

6. The kneading machine according to claim 4, wherein the opening of the battery case is provided between a highest position and a lowest position of the input opening at a time when the drum tilts about the tilting shaft.

7. The kneading machine according to claim 1, further comprising vehicle wheels provided on the pedestal and in contact with a ground surface,
wherein the battery case is disposed at a higher position than the vehicle wheels; and
the motor is disposed at a higher position than the opening of the battery case and at a lower position than a highest position of the input opening of the drum.

8. The kneading machine according to claim 1, wherein the battery case and the motor are adjacent to each other.

9. The kneading machine according to claim 1, wherein the drum serves in a dual manner as the stirring member.
